(19) United States
(12) Patent Application Publication
(10) Pub. No.: US 2024/0274912 A1
(43) Pub. Date: Aug. 15, 2024

(54) EXTRACTION OF METALS FROM LITHIUM-ION BATTERY MATERIAL

(71) Applicant: METSO FINLAND OY, Espoo (FI)

(72) Inventors: Tuomas VAN DER MEER, Espoo (FI); Marika TIIHONEN, Espoo (FI); Annukka MAKINEN, Espoo (FI); Niko ISOMAKI, Espoo (FI); Roshan BUDHATHOKI, Espoo (FI)

(73) Assignee: METSO FINLAND OY, Espoo (FI)

(21) Appl. No.: 18/555,062

(22) PCT Filed: Apr. 14, 2021
(86) PCT No.: PCT/FI2021/050268

§ 371 Date: Oct. 12, 2023

(51) Int. Cl. H01M 10/54; C22B 1/02; C22B 3/00; C22B 3/02; C22B 3/08; C22B 3/32; C22B 3/38; C22B 3/42; C22B 3/44; C22B 7/00; C22B 15/00; C22B 23/00; C22B 26/12; C22B 47/00

(52) U.S. Cl. CPC H01M 10/54; C22B 1/02; C22B 3/02; C22B 3/08; C22B 3/326; C22B 3/3842; C22B 3/42; C22B 3/44; C22B 7/007; C22B 15/0013; C22B 15/0071; C22B 15/0089; C22B 23/005; C22B 23/043; C22B 23/0461; C22B 26/12; C22B 47/00

(57) ABSTRACT

A method for extracting metals from the black mass of lithium-ion batteries, the black mass containing the anode and cathode materials of the batteries, wherein the cathode material comprises lithium, nickel, and cobalt. The method is carried out by an arrangement that is suitable for use in the method.

### BACKGROUND OF THE INVENTION

### Field of the Invention

The present invention relates to a method for extracting metals from lithium-ion battery material, particularly from the black mass obtained from said battery material. Such a black mass contains mainly cathode metals and anode material, and the cathode metals, in turn, typically comprise lithium, nickel and cobalt, further possible cathode metals being manganese and aluminium. The invention also relates to an arrangement that is suitable for use in the method.

### Description of Related Art

The use of lithium-ion batteries has grown steadily for the last years, and their importance appears to grow even further as the development of new electric vehicles continues. Lithium ion batteries contain, in their cathodes, several transition metals that can be valuable when recovered from these batteries, either for reuse in new batteries or for other purposes.

Pyrometallurgical processes have been used in the past to separate these cathode metals from other battery components, but these are high-cost processes with a high environmental impact, and the losses of metals tend to be high. Therefore, hydrometallurgical separations have become more common.

Hydrometallurgical separations of metals from lithium-ion batteries proceed via the recovery of a black mass, which contains cathode metals and anode material, but from which wiring and other coarse solid battery components, such as plastic or steel parts, have already been removed.

The next step in the recovery of the metals, after the formation of the black mass, is typically the separation of the cathode metals from the other components of the black mass, e.g. using acid leaching to solubilize the cathode metals, possibly with the use of a reducing agent to increase the solubility of the target metals.

The present inventors have now found that the acid leaching, optionally in reducing conditions, as well as the subsequent recoveries of separate metals, can be made more efficient by optimizing the choice of reagents. Thus, more efficient procedures for solubilizing metal oxides in the hydrometallurgical processing of black mass can be provided, also resulting in selective recoveries of metals in the subsequent steps of the method.

### SUMMARY OF THE INVENTION

The invention is defined by the features of the independent claims. Some specific embodiments are defined in the dependent claims.

According to a first aspect of the present invention, there is provided a method for extracting metals from the black mass obtained from lithium-ion battery material, the black mass containing the anode and cathode materials of the batteries. Particularly, the metals that are extracted include transition metals, more particularly at least one of lithium, nickel and cobalt.

According to a second aspect of the invention, there is provided a method for extracting said cathode metals from the black mass by utilizing an acid leaching step.

According to a third aspect of the invention, there is provided a method including the acid leaching of said metals from the black mass in a sulphuric environment.

According to a fourth aspect of the invention, the leaching is a reductive leaching, using SO₂ as reducing agent, while a gas containing molecular oxygen is used to provide an even more efficient solubilization.

According to a further aspect of the invention, there is provided an arrangement suitable for use in carrying out the steps of the method of the invention.

The method of the invention thus comprises
one or more leaching steps, including an acid leaching step, and
the metal separation steps required to recover the desired transition metals, typically as fractions including at least one of lithium, cobalt and nickel ions.

Likewise, the arrangement of the invention comprises
one or more leaching units, from which a leach solution containing the dissolved cathode material is recovered, and
metal separation units, for recovering fractions including at least one of lithium, cobalt and nickel ions.

Thus, the invention is related to the use of SO₂ and a gas containing molecular oxygen in the acid-leaching of metals of black mass, thus providing a more efficient solubilisation of the transition metals contained therein, as compared to common leaching procedures.

The sulphuric acid used in the present method forms the basis of the sulfatization of the cathode metals in the black mass, required to solubilize these metals. In fact, the sulphuric acid is capable of converting any cathode metals, in their lowest oxidation number, into their more soluble sulphates.

The gas containing molecular oxygen, in turn, controls the acidity of the solution, and provides a more efficient solubilization, while the SO₂ converts certain metal ions into a more soluble oxidation state. For example, manganese and cobalt ions tend to exist at least partly in their sparely soluble oxidation states, Mn⁴⁺ and Co³⁺, whereby a reducing agent converts them into the more soluble states, Mn²⁺ and Co²⁺.

It has been shown in the past that a reducing agent is beneficial for improving the leaching of cobalt and manganese from the cathode material of lithium-ion batteries. The inventors have now found that SO₂ is a preferred choice of reducing agent, among others due to its capability to compensate for the need of acid. Sulphur dioxide has the further advantage of being gaseous, whereby it does not require dilution with water, and also leaves no traces in the solution. Particularly unreacted oxidants or reductants can be harmful in solvent extraction circuits, as the organics used in these solvent extractions can be degraded, resulting in poor performance and increased need for replacing the organics used.

The present invention thus provides several advantages. Among others, high efficiency solubilisation is possible by operating in a sulphate solution, by adjusting the pH of the leaching solution to a suitable operating window and by feeding an oxygen-containing gas to the leaching unit, together with the selected reducing agent, i.e. sulphur dioxide (SO₂), both fed to the leaching at a suitable rate.

Along the function as a reductant enabling the dissolution of metals, the SO₂ also produces acid and compensates for some of the need for sulphuric acid addition.

### BRIEF DESCRIPTION OF THE DRAWINGS

FIG. 1 is a diagram illustrating the units of the arrangement according to the invention.

FIG. 2A and FIG. 2B are diagrams illustrating the units of the arrangement according to two separate embodiments of the invention.

FIG. 3 is a graph illustrating the effect of the pH of the leach solution on the recoveries of different metals, when supplying a feed of O₂ gas to the leach solution.

FIG. 4 is a graph illustrating the effect of the pH of the leach solution on the recoveries of different metals, when supplying a gas feed of an SO₂/air mixture to the leach solution.

### EMBODIMENTS OF THE INVENTION

### Definitions

In the present context, the term “black mass” is intended to describe the mixture of cathode and anode material that is obtained after a mechanical separation of the components of batteries, the black mass typically also containing organic compounds depending on the black mass pre-treatment method, such as the compounds originating from the electrolytes of the batteries.

“Organic compounds” are herein intended to encompass molecules, where one or more atoms of carbon are covalently linked to one or more atoms of hydrogen, oxygen or nitrogen. Thus, e.g. graphite or other allotropes of pure carbon, are excluded from this group of compounds. Other compounds commonly considered to be excluded from this class of compounds, despite fulfilling the definition, include carbonates and cyanides, if the only carbon of the compound is based in this group, as well as carbon dioxide.

The “anode” is typically formed of e.g. graphite or silicon, which are not solubilized in the leaching of the invention, but are present in the black mass before leaching.

The “cathode material” or “cathode metals”, in turn, encompass metal ions, such as lithium, nickel, cobalt and manganese (Li, Ni, Co and Mn), typically in the form of their oxides. The contents of these metals in the black mass are preferably all within the range of 1-35% by weight. Other examples of cathode components that may be present in the black mass, usually however in smaller amounts, include tin, zirconium, zinc, copper, iron, fluoride, phosphorus and aluminium (i.e. Sn, Zr, Zn, Cu, Fe, F, P and Al).

The present invention relates to a method for extracting metals from the black mass of lithium-ion battery material. The method comprises the following steps:
a) one or more pre-treatment steps, wherein a fraction of non-metallic material is separated from the black mass, and a pre-treated black mass containing anode and cathode materials is recovered, and preferably treated further by leaching,
b) one or more leaching steps, including an acid leaching carried out in a solution containing sulphuric acid, by further adding as extractants sulphur dioxide and a gas containing molecular oxygen, whereby the cathode material of the pre-treated black mass is dissolved, and a leach solution containing the dissolved cathode material is recovered, and preferably treated further by separating metallic fractions therefrom, and
c) metal separation steps, wherein initial fractions of metallic material are separated from the leach solution and main fractions including at least one of cobalt, nickel and lithium are recovered.

The black mass of lithium ion batteries typically contains both cathode and anode materials, as well as electrolyte materials with organic compounds. For the purposes of the invention, the organic compounds are preferably removed from the black mass by the above mentioned pre-treatment step(s), since the presence of organic compounds might prevent the separation of metals from the leach solution after the leaching step.

For example, one or more washing steps can be used as pre-treatment steps, preferably carried out by mixing the battery material with water or an organic solvent, most suitably with water, whereby material that is dissolved or dispersed in said solvent, such as said organic compounds, can be separated from the undissolved components of the black mass. Alternatively, one or more heating steps, typically carried out as pyrolysis or evaporation steps, can be used to remove organic compounds, preferably carried out at a temperature of 195-470° C. A further option is to carry out both a washing step and one of the mentioned heating procedures.

The pre-treatment step(s) thus yield a pre-treated black mass that preferably contains the lithium, nickel and cobalt, and possibly manganese, of the battery cathode, in oxide form, and more preferably contains only <3% by weight of remaining organic compounds, most suitably <1.5% by weight.

In a preferred embodiment of the invention, at least a fraction of the lithium typically lost in the optional washing steps is recovered by
a step of reacting the used washing solution, separated from the remaining solids and containing the separated fraction of non-metallic material, with a phosphate reagent, to cause precipitation of the lithium therein into lithium phosphate, and
a step of separating the lithium phosphate precipitate from the remaining washing solution and combining it with the pre-treated black mass that is carried to the following leaching step(s).

After the pre-treatment step(s), a solid/liquid separation is typically carried out, whereby the pre-treated black mass can be carried to the following leaching step, and optionally mixed with added metal-containing solids or slurry, such as a lithium phosphate precipitate recycled from either the pre-treatment steps or the metal recovery steps.

In an embodiment of the invention, only one leaching step is used, which is said acid leaching step, carried out in a solution containing sulphuric acid. Typically, the acid leaching is thus carried out by dispersing the pre-treated black mass into a solution containing the acid, and adding the extractants, preferably followed by mixing.

The temperature during the leaching step is preferably adjustable, whereby the temperature most suitably is maintained at an elevated level during the acid leaching, such as a temperature of >50° ° C., preferably a temperature of 50-95° C., and more preferably a temperature of 60-90° C. Similarly, the pressure during the acid leaching is preferably maintained at atmospheric pressure, or slightly elevated pressure of 100-200 kPa. Typically, the solubilisation of the desired transition metals is complete within a time of 2-6 hours.

The sulphuric acid addition is used in part to adjust the pH of the leaching solution. The pH of the leaching solution is thus preferably adjusted to a level of 0-5, more preferably 1-2, using said sulphuric acid, before adding the extractants.

An efficient solubilisation of the desired cathode components is strongly facilitated by the presence of a reducing agent. In the present invention, sulphur dioxide (SO₂) is used, to maintain or further reduce metals, such as cobalt and manganese, of the washed black mass to their less oxidized state, i.e. to keep these metal ions in the solution phase.

The gas containing molecular oxygen used in the acid leaching is needed to provide a more efficient solubilisation of the cathode metals. This oxygen-containing gas can be selected from any gas or gas mixture containing molecular oxygen, i.e. O₂ or O₃, preferably in the form of O₂, mixed with mainly inert gases, the other gases preferably functioning mainly as diluents. For example, the gas can have an oxygen content of 15-100 vol-%. Typically, this oxygen-containing gas is selected from air, which contains about 21 vol-% molecular oxygen (O₂), or from pure molecular oxygen in the form of O₂, preferably being air, since undiluted molecular oxygen may cause a need for increasing the feed of sulphur dioxide.

Regardless of the choice of gas, it is preferred to add the sulphur dioxide and the gas containing molecular oxygen at a volume ratio of SO₂:O₂ that is adjusted to a level of 0.5:1-1.5:1, preferably to a level of 0.7:1-1.3:1. In an embodiment, the ratio is adjusted to a level of 0.5:1-0.99:1, so that the content of SO₂ is smaller than the content of O₂, and more preferably to a level of 0.7:1-0.9:1

The feed rates of oxygen-containing gas and SO₂ are, in turn, preferably coupled with the stoichiometric feed rate based on the amount of metals in the pre-treated black mass, and is most suitably fine-tuned based on parameters such as the redox potential.

After the leaching reaction is complete, i.e. after the pre-treated black mass has spent a sufficient amount of time, such as 2-6 hours, in the leaching conditions, a solid/liquid separation is typically carried out, in order to recover the leach solution containing the cathode metals, whereby it can be carried to the following step of the method, for recovery of separate metallic fractions.

In an embodiment of the invention, the recovery of main fractions of metallic material including at least one of cobalt, nickel and lithium ions is preferably preceded by the one or more steps for separating initial fractions of metallic material from the leach solution. Said initial fractions of metallic material (or “the initial metallic fractions”) typically include at least one of iron, aluminium, calcium and fluoride ions, and possible phosphates. This order of steps has the advantage of providing a purified solution for the recovery of the main fractions of metallic material, since the initial fractions include the materials that are considered to belong to the impurities. These materials would also impair the subsequent recoveries of the main fractions, or at least result in lower purity or lower yields, if left in the leach solution.

Preferably, the step(s) for separating initial fractions of metallic material from the leach solution include the steps for separating two or more of, preferably three or four of, and most suitably all of, iron, aluminium, calcium and fluoride ions. Also copper and phosphates can be included in these initial fractions. Optionally, a separate copper recovery step can be carried out, preferably before the other initial fraction(s) are separated from the solution.

Typically, the separation(s) of initial fractions of metallic material include at least one step carried out as a solvent extraction (SX), intended to remove said impurities, such as iron and aluminium, from the leach solution, optionally preceded by a solid separation, to remove any impurities already in solid form, thus increasing the selectivity of the solvent extraction.

In another alternative, the separation(s) of initial fractions of metallic material include at least one step carried out as a precipitation, for example a hydroxide precipitation, intended to remove impurities, such as iron and aluminium, and possible phosphates, as a solid fraction from the leach solution.

In a particularly preferred alternative, the separation of initial fractions of metallic material includes a precipitation, with an optional separation of the impurities from the leach solution, followed by a solvent extraction, both steps as described above. The advantage of such a two-step impurity separation is that the contents of impurities, such as iron and aluminium, are further decreased in the thus purified leach solution. It is particularly preferred to carry out the precipitation before the solvent extraction in such a two-step separation of initial metallic fractions, since this will facilitate a high selectivity in the solvent extraction.

In case the copper is separately recovered, this copper recovery step is preferably carried out before said initial fractions of metallic material are separated from the leach solution, since copper can have a negative impact on subsequent recoveries and more importantly product qualities.

Since the acid leaching step has been carried out in an acid solution, the first metal separation step is required to endure acidic conditions. This requirement is fulfilled for the separations of the initial metallic fractions.

Various reactions and procedures can be utilized to carry out said metal separations and recoveries, such as further leaching or washing steps, solvent extractions, precipitations, ion exchange steps, and electrowinning steps. However, for the separations of the initial metallic fractions it is preferred to utilize at least one solvent extraction, since this will result in a higher purity of the remaining solution, thus also facilitating the subsequent recoveries of the main fractions, particularly the recovery of cobalt and nickel, whereby all of the metals of the main fractions can be recovered in high yield and high purity, typically as battery-grade materials.

As mentioned above, the recoveries of the main fractions of metals include steps for recovering at least one of cobalt, nickel and lithium ions, and possibly manganese, although they can be recovered in varying order.

Particularly, the recoveries of the main fractions include steps for recovering two or more of, preferably three or four of, and most suitably all of, manganese, cobalt, nickel and lithium ions, from the leach solution, lithium being one of the preferred metal to recover, along with nickel and cobalt.

Thus, at least one of lithium, nickel and cobalt is recovered, optionally together with manganese, preferably at least two of the manganese, lithium, cobalt and nickel, more preferably two or three of these, most suitably all four of these. Typically, any manganese, cobalt and nickel is recovered before said lithium.

A lithium recovery is thus preferably carried out after the separation of the initial metallic fractions, and more preferably also after any of the manganese, cobalt, and nickel present in the leach solution have been recovered. Using this preferred order of steps will result in a situation, where the lithium can be recovered from a high-purity lithium-containing solution.

Typically, the lithium is recovered by reacting the lithium into its carbonate or phosphate, producing a product fraction that can be recovered as such, or alternatively be further converted into e.g. lithium hydroxide, which can then be crystallized into pure hydroxide crystals.

A further option for the lithium recovery is to use a solvent extraction, after which a further conversion or crystallization can be carried out. The benefit of this procedure is an even higher lithium recovery.

In an embodiment of the invention, the lithium is recovered into its carbonate, producing a product fraction that can be recovered by a solid/liquid separation, and the solid product fraction be collected as such, or alternatively be further converted into e.g. lithium hydroxide. The liquid fraction can, in turn, be reacted further with a phosphate reagent, and possibly a separate precipitation reagent, thus causing precipitation of the lithium remaining therein into a lithium phosphate precipitate. This precipitate can be carried either to the lithium recovery, e.g. by combining it with the carbonate or phosphate product fraction, or it can be recycled to the leaching step, by mixing it with the pre-treated black mass. A further option is to carry a fraction of the precipitate to each of these.

The phosphate reagent used above can be selected from any phosphates of alkali or carth alkali metals. However, sodium phosphate (Na₃PO₄) is preferred, since it brings no new cations to the reaction mixture, and since it has a suitable reactivity.

The optional precipitation reagent is preferably selected from alkaline agents, such as sodium hydroxide, functioning by increasing the pH of the solution, thus facilitating the precipitation of the desired lithium phosphate.

A nickel recovery is also preferred, particularly carried out on the leach solution after the separation of the initial metallic fractions, typically taking place either simultaneously with or directly after the recovery of cobalt, more preferably after the cobalt is recovered, and most suitably before any lithium is recovered. Similarly, it is preferred to carry out the nickel recovery after an optional manganese recovery.

Said nickel recovery can be carried out, for example using a solvent extraction (SX), which produces a rather pure nickel sulphate solution (NiSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for nickel recovery is most suitably carried out using extraction chemicals having a carboxylic acid functional group, one commercial example of suitable extraction chemicals being Versatic™ 10, which is a neodecanoic acid.

A cobalt recovery is also preferably carried out on the leach solution after the separation of the initial metallic fractions, typically taking place either simultaneously with or directly before the recovery of nickel, more preferably before the nickel is recovered, and most suitably also before any lithium is recovered. Similarly, it is preferred to carry out the cobalt recovery after an optional manganese recovery.

A preferred option for said cobalt recovery is a solvent extraction (SX), which produces a rather pure cobalt sulphate solution (CoSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for cobalt recovery is most suitably carried out using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

In one alternative manner of proceeding with the metal separation steps, as indicated above, cobalt and nickel can be recovered simultaneously from the leach solution, for example by a solvent extraction, thus producing a sulphate solution, optionally followed by a further purification by ion exchange (IX), or a precipitation into the hydroxides or the carbonates. Alternatively, the sulphate solution can be used as such, without crystallization or precipitation, e.g. in the preparation of new cathode materials.

According to an embodiment of the invention, the metal separation steps include a step for recovering manganese from the leach solution, the manganese recovery also carried out after the separation of the initial metallic fractions. Preferably, the manganese is recovered before the nickel or the cobalt, and most suitably before either the nickel, cobalt or lithium are recovered.

Options for said manganese recovery include solvent extractions, precipitations and crystallizations, or a solvent extraction followed by a precipitation or crystallization. One particularly preferred option is to utilize an oxidative precipitation using sulphur dioxide, SO₂, and air, to form the manganese oxide, MnO₂.

The method of the invention can be carried out in any suitable apparatus or arrangement, with the units and equipment needed to carry out the steps of the method.

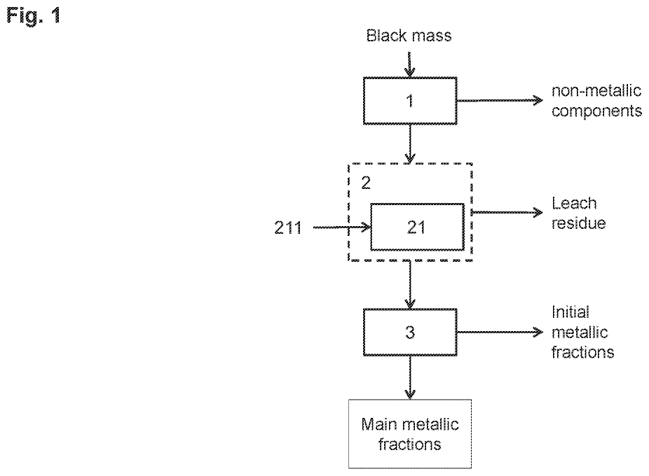

In one embodiment of the invention, the method described above is carried out using the arrangement of FIG. 1, which comprises the following units:
one or more pre-treatment units 1 for separating a fraction of non-metallic components from the black mass, and recovering a pre-treated black mass containing the anode and cathode materials, preferably intended to be conducted via suitable connections to a downstream leaching unit 2,
one or more leaching units 2, for dissolving the cathode material of the pre-treated black mass and recovering a leach solution containing said dissolved cathode material, preferably intended to be conducted via suitable connections to a downstream separation unit 3, at least one leaching unit 2 being in the form of an acid leaching unit 21, with inlets 211 for sulphuric acid and extractants, and
metal separation units 3 for separating metallic material from the leach solution and recovering fractions including at least one of cobalt, nickel and lithium as product fractions.

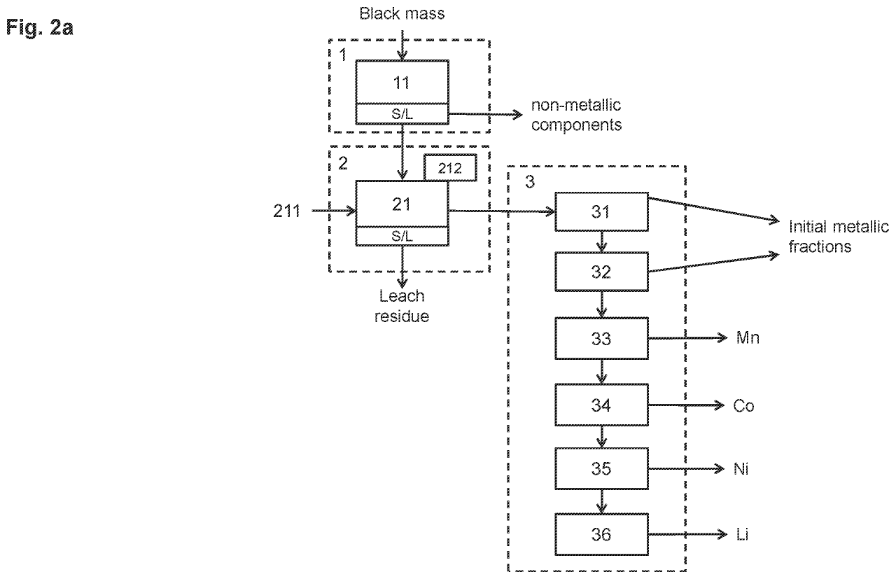

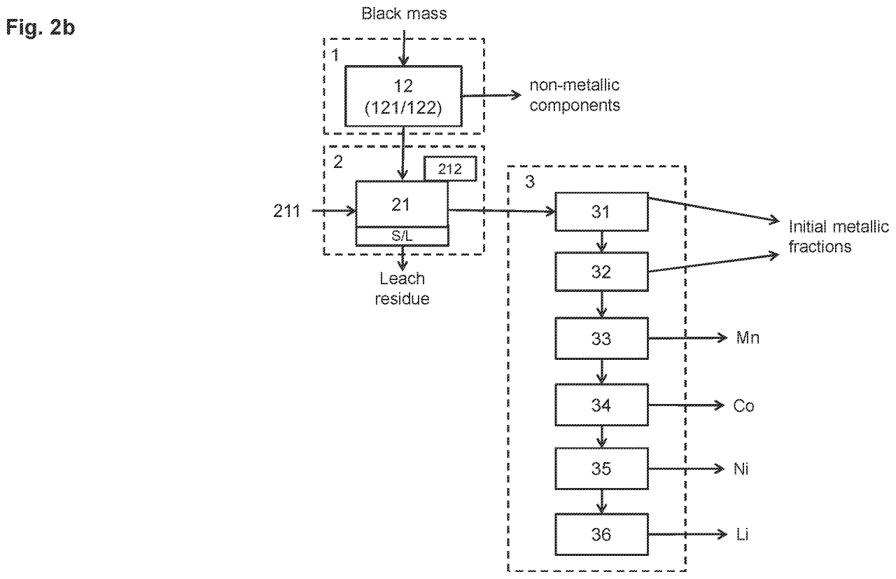

In an embodiment of the invention, with various options shown in FIGS. 2A and 2B, the pre-treatment unit(s) 1 include a washing unit 11 or a heating unit 12, or both, for removing non-metallic components, such as organic compounds, from the black mass, the heating unit 12 most suitably selected from a pyrolysis unit 121 or an evaporation unit 122. The optional washing unit 11 is preferably further equipped with a water inlet.

The leaching unit(s) 2 typically consist of only said acid leaching unit(s) 21, which in turn is preferably equipped with the required inlets 211 for sulphuric acid and extractants, as well as means 212 for adjusting the temperature, which can incorporate either heating or cooling, as shown in FIGS. 2A and 2B.

The metal separation units 3 preferably include several subunits, the preferred options illustrated in FIGS. 2A and 2B, all subunits typically equipped with the further subunits (e.g. solvent extraction units, ion exchange units, precipitation units, electrowinning units, washing units or solid/liquid separation units), recycle lines, inlets and outlets needed to carry out the reactions they are intended for.

Preferably, one or more units 33,34,35,36 for recovering main fractions of metallic material containing at least one of cobalt, nickel and lithium ions are preceded by one or more units 31,32 for separating initial fractions of metallic material from the leach solution, said units 31,32 for separating initial fractions most suitably including at least one solvent extraction unit.

In case copper is separately recovered in the arrangement, the copper recovery unit 31 is preferably placed upstream from the other unit(s) 32 for separating initial metallic fractions from the leach solution.

Various types of units and equipment can be utilized to carry out said separations and recoveries, such as further leaching or washing units, solvent extraction units, precipitation units, ion exchange units, and electrowinning units. However, solvent extraction units are preferred. Particularly, it is preferred to utilize at least one solvent extraction unit for the separations of the initial metallic fractions. More preferably, the solvent extraction is preceded by a solid separation unit, which, in turn, optionally is preceded by a precipitation unit for such impurities.

The units 33,34,35,36 for recovering the main fractions of metallic material thus include units for recovering at least one of cobalt, nickel and lithium ions, placed in any suitable order.

In a preferred embodiment of the invention, the unit(s) 34,35 for recovering at least one of cobalt and nickel are positioned upstream from the unit 36 for recovering lithium, the latter preferably including subunits for reacting the lithium into its corresponding carbonate or phosphate, optionally followed by a subunit for converting the lithium further into lithium hydroxide, which can be followed by a crystallization subunit.

In another preferred embodiment of the invention, a unit 33 for recovering manganese is included in the arrangement, and is positioned upstream from the unit(s) 34,35,36 for recovering at least one of cobalt, nickel and lithium.

In one alternative manner of selecting and positioning the metal separation units 3, the cobalt and the nickel can be recovered in the same unit 34/35.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

The following non-limiting examples are intended merely to illustrate the advantages obtained with the embodiments of the present invention.

### EXAMPLE—Effect of pH and Gas Feed on Leaching of Black Mass

A black mass containing nickel, cobalt, lithium, manganese, aluminium and iron, in oxide form, was subjected to an 8-hour leaching in an aqueous solution at a temperature of 80ºC. Seven leaching tests were conducted as shown in Table 1 below, using identical reactor volumes, and using leaching solutions having pH levels between 0.5 and 3, adjusted using sulphuric acid, and using different leaching reagents.

In one set of tests (L1-L5), the leaching was carried out by oxidizing the metals in the leaching solution with an oxygen gas feed (O₂), and in another set of tests (L11 and L15), the leaching was carried out in reductive conditions using a mixed gas feed of sulphur dioxide (SO₂) and air (containing oxygen, O₂) as reagents.

TABLE 1
Test conditions

| | | Temper- | | | Gas | Gas | S/L |
|---|---|---|---|---|---|---|---|
| | | ature | Residence | Gas | ratio, | flow, | ratio, |
| Test | pH | ° C. | Time, h | feed | % | mL/min | g/L |
| L1 | 0.5 | 80 | 8 | O2 | 100 | 200 | 100 |
| L2 | 1 | 80 | 8 | O2 | 100 | 200 | 100 |
| L3 | 1.5 | 80 | 8 | O2 | 100 | 200 | 100 |
| L4 | 2 | 80 | 8 | O2 | 100 | 200 | 100 |
| L5 | 3 | 80 | 8 | O2 | 100 | 200 | 100 |
| L11 | 1 | 80 | 8 | SO2 + air | 15 + 85 | 500 | 200 |
| L15 | 1.5 | 80 | 8 | SO2 + air | 15 + 85 | 500 | 200 |

The results of these tests, showing the recoveries of various metals in the leach solution after leaching, indicate that excellent metal yields are possible to achieve by optimizing the pH and selecting the most suitable feed of gas reagents during the leaching step.

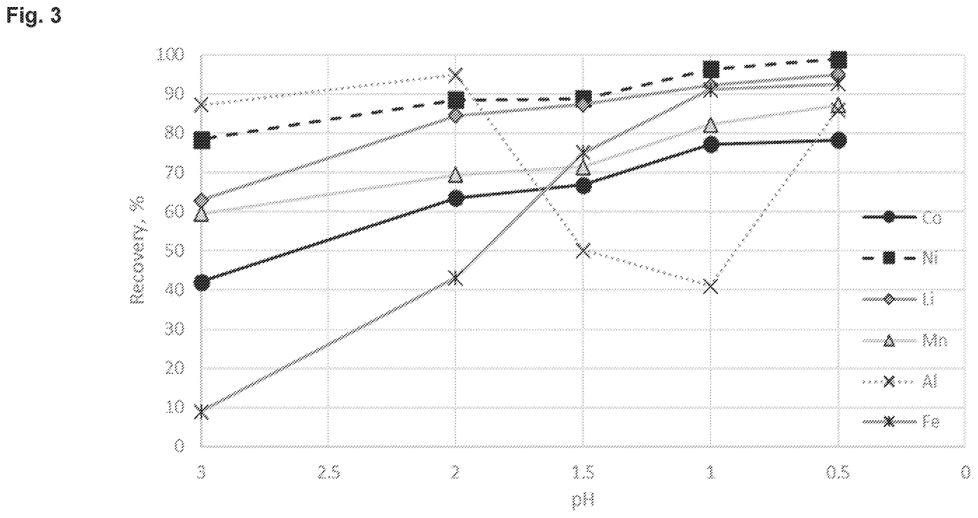

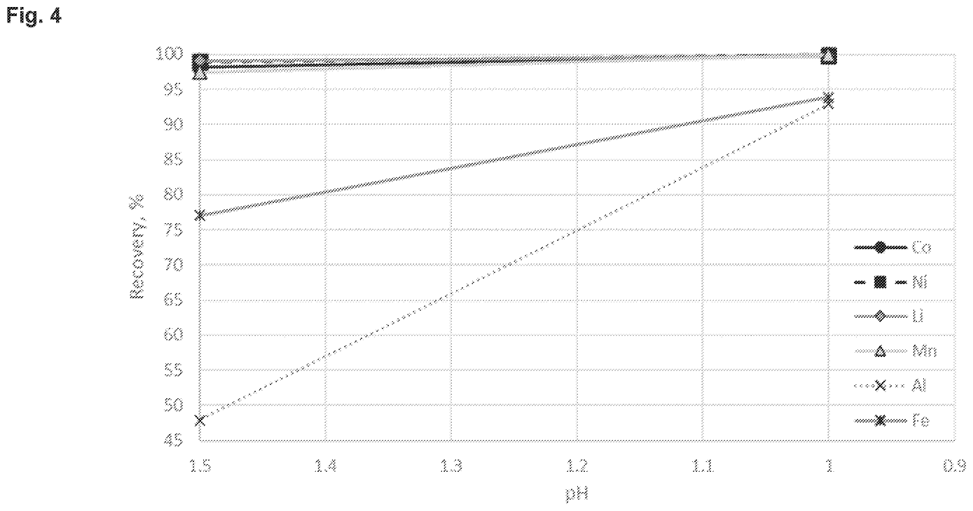

As the results of FIG. 3 show, acidic conditions are required in order to optimize said metal recoveries, while FIG. 4 shows that all metal recoveries benefit from using a reductive gas mixture. In such reductive conditions, cobalt, nickel, lithium and manganese can be recovered at an almost 100% yield, regardless of the choice of pH. Aluminium and iron are, in turn, strongly affected by the pH even in said reductive conditions.

### INDUSTRIAL APPLICABILITY

The present method, and the arrangement suitable for use in said method, can be used to replace conventional alternatives for recovery of metals from the black mass obtained from lithium-ion batteries.

In particular, the present method and arrangement provides an economical and efficient procedure for recovering at least one of cobalt, nickel and lithium, as well as optionally manganese, in good yields from such battery material.

### REFERENCE SIGNS LIST

As shown in the Figures (see FIGS. 1 and 2), the following units and inlets can be included in the arrangement of the present invention, according to one or more embodiments of the invention:
1 Pre-treatment unit, including or consisting of:
   11 Washing unit, typically with a solid/liquid separation subunit,
   12 Heating unit, e.g. in the form of
      121 Subunit for pyrolysis
      122 Subunit for evaporation
2 Leaching unit, typically with a solid/liquid separation unit, the leaching unit including or consisting of:
   21 Acid leaching unit, including
      211 Inlets for acid and extractants
      212 Means for adjusting the temperature
3 Metal separation units, including:
   31 Optional unit for recovering metallic material
   32 Unit for separating initial fraction(s) of metallic material
   33 Optional unit for recovering manganese
   34 Unit for recovering cobalt
   35 Unit for recovering nickel
   36 Unit(s) for recovering lithium

1. A method for extracting metals from the black mass of lithium-ion batteries, the black mass containing the anode and cathode materials of the batteries, wherein the cathode material comprises lithium, nickel, and cobalt, the method comprising the following steps:
a) one or more pre-treatment steps, wherein a fraction of non-metallic material is separated from the black mass, and a pre-treated black mass containing anode and cathode materials is recovered,
b) one or more leaching steps, including an acid leaching step carried out in a solution containing sulphuric acid, by further adding as extractants sulphur dioxide and a gas containing molecular oxygen to this acid leaching step, whereby the cathode material of the pre-treated black mass is dissolved, and a leach solution containing the dissolved cathode material is recovered, and
c) metal separation steps, wherein initial fractions of metallic material are separated from the leach solution and main fractions including at least one of cobalt, nickel and lithium are recovered.

2. The method according to claim 1, which is used to extract metals from black mass, wherein the cathode material comprises the lithium, nickel, and cobalt, and optionally one or both of manganese and aluminium, in oxide form.

3. The method according to claim 1, wherein the pre-treatment step(s) include one or more steps of washing or heating, or both, the heating preferably carried out to provide a pyrolysis or an evaporation.

4. The method according to claim 1, wherein the pre-treatment step(s) are carried out to cause separation of non-metallic components, such as organic compounds, from the black mass, thus resulting in a pre-treated black mass containing <3% by weight of organic compounds, preferably <1.5% by weight.

5. The method according to claim 1, wherein the gas containing molecular oxygen that is used in the leaching step(s) is a gas or a gas mixture containing oxygen in the form of O₂ or O₃, the gas preferably being air or molecular oxygen in the form of O₂, preferably being air.

6. The method according to claim 1, wherein the sulphur dioxide and the gas containing molecular oxygen are added at a volume ratio of SO₂:O₂ that is adjusted to a level of 0.5:1-1.5:1 in the acid leaching step, preferably to a level of 0.7:1-1.3:1.

7. The method according to claim 1, wherein the acid leaching is carried out in a single step, proceeding by dispersing the pre-treated black mass, optionally mixed with added metal-containing solids or slurry, into a solution containing both the acid and the extractants.

8. The method according to claim 1, wherein the acid leaching step is carried out at a temperature of >50° C., preferably 50-95° C., and more preferably a temperature of 60-90° C.

9. The method according to claim 1, wherein the acid leaching step is carried out at atmospheric pressure, or slightly elevated pressure of 100-200 kPa.

10. The method according to claim 1, wherein the metal separation steps include one or more steps for recovering main fractions of metallic material, containing at least one of cobalt, nickel and lithium ions, preceded by one or more steps for separating initial fractions of metallic material from the leach solution.

11. The method according to claim 1, wherein the metal separation steps include one or more steps for separating initial fractions of metallic material from the leach solution, said initial fractions of metallic material including at least one of iron, aluminium, calcium and fluoride ions, and optionally phosphate ions, the initial fractions preferably including two or more of, more preferably three or four of, and most suitably all of, iron, aluminium, calcium and fluoride ions.

12. The method according to claim 1, wherein the metal separation steps include one or more steps for separating initial fractions of metallic material from the leach solution, said steps including at least one step carried out as a solvent extraction, intended to remove impurities, such as iron and aluminium, from the leach solution, optionally preceded by a solid separation, to remove any solid impurities and increase the selectivity of the solvent extraction.

13. The method according to claim 1, wherein the metal separation steps include one or more steps for separating initial fractions of metallic material from the leach solution, said steps including at least one step carried out as a precipitation, intended to remove impurities, such as iron and aluminium, as well as phosphates that might be present, from the leach solution, preferably followed by a solvent extraction.

14. The method according to claim 1, wherein the metal separation steps include one step for recovering copper from the leach solution, preferably carried out before any other separations or recoveries of metallic material.

15. The method according to claim 1, wherein the metal separation steps include steps for recovering at least two of manganese, cobalt, nickel and lithium ions as main fractions of metallic material, preferably for recovering three or four of, and most suitably all of, manganese, cobalt, nickel and lithium ions.

16. The method according to claim 1, wherein at least lithium and one or more of manganese, cobalt and nickel ions are recovered in the metal separation steps, whereby at least one of the manganese, cobalt and nickel is recovered before the lithium.

17. The method according to claim 1, wherein the metal separation steps include a step for recovering lithium from the leach solution, preferably carried out after manganese, cobalt, and nickel present in the leach solution have been recovered, the lithium being recovered e.g. by reacting the lithium with a carbonate or a phosphate reagent, optionally followed by a further conversion, an evaporation or a crystallization.

18. The method according to claim 1, wherein cobalt and nickel are recovered from the leach solution, in a simultaneous recovery step or separate recovery steps, preferably in separate steps.

19. The method according to claim 1, wherein nickel is recovered from the leach solution by solvent extraction, which produces a nickel sulphate solution (NiSO₄), preferably using extraction chemicals having a carboxylic acid functional group, one commercial example of suitable extraction chemicals being Versatic™ 10, which is a neodecanoic acid.

20. The method according to claim 1, wherein nickel is recovered from the leach solution by solvent extraction that produces a nickel sulphate solution, which solution is utilized as such, or it is purified further, e.g. by ion exchange and optionally a crystallization, or it is precipitated into a hydroxide or a carbonate.

21. The method according to claim 1, wherein cobalt is recovered from the leach solution, either simultaneously with or directly before a recovery of nickel, preferably directly before the recovery of nickel.

22. The method according to claim 1, wherein cobalt is recovered from the leach solution by solvent extraction, which produces a cobalt sulphate solution (CoSO₄), preferably using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

23. The method according to claim 1, wherein cobalt is recovered from the leach solution by solvent extraction that produces a cobalt sulphate solution, which solution is utilized as such, or it is purified further, e.g. by ion exchange and optionally a crystallization, or it is precipitated into a hydroxide or a carbonate.

24. The method according to claim 1, wherein the metal separation steps include a step for recovering manganese from the leach solution, preferably carried out before the nickel or the cobalt is recovered, more preferably before any of the cobalt, nickel or lithium is recovered, the manganese recovery carried out e.g. by solvent extraction or precipitation, or by a solvent extraction followed by a precipitation.

25. An arrangement for extracting metals from the black mass of lithium-ion batteries, the black mass containing the anode and cathode materials of the batteries, wherein the cathode material comprises lithium, nickel and cobalt, the arrangement comprising:
one or more pre-treatment units for separating a fraction of non-metallic components from the black mass, and recovering a pre-treated black mass containing the anode and cathode materials,
one or more leaching units, for dissolving the cathode material of the pre-treated black mass and recovering a leach solution containing said dissolved cathode material, at least one leaching unit being in the form of an acid leaching unit, with inlets for sulphuric acid and extractants, and
metal separation units for separating metallic material from the leach solution and recovering fractions including at least one of cobalt, nickel and lithium.

26. The arrangement according to claim 25, wherein the pre-treatment unit(s) include a washing or a heating unit, or both, for removing non-metallic components, such as organic compounds, from the black mass, the heating unit preferably selected from a pyrolysis unit or an evaporation unit.

27. The arrangement according to claim 25, wherein the leaching unit(s), preferably at least the acid leaching unit is equipped with means for adjusting the temperature.

28. The arrangement according to claim 25, wherein the metal separation units include one or more units for recovering main fractions of metallic material, including at least one of cobalt, nickel and lithium ions, preferably preceded by one or more units for separating initial metallic fractions from the leach solution, most suitably including at least one solvent extraction unit.

29. The method according to claim 1, which is carried out using the arrangement of claim 25.
